(19) United States
(12) Patent Application Publication
(10) Pub. No.: US 2016/0210434 A1
(43) Pub. Date: Jul. 21, 2016

(54) HEALTH INFORMATION MONITORING DEVICE AND METHOD

(71) Applicant: UMM AL-QURA UNIVERSITY, Makkah (SA)

(72) Inventor: Nora Hussain Basha AL-SHARIF, Mecca - Sabhani (SA)

(73) Assignee: UMM AL-QURA UNIVERSITY, Makkah (SA)

(21) Appl. No.: 14/996,769

(22) Filed: Jan. 15, 2016

Related U.S. Application Data
(60) Provisional application No. 62/103,848, filed on Jan. 15, 2015.

(51) Int. Cl. G06F 19/00; G06F 21/32

(52) U.S. Cl. CPC G06F 19/3431; G06F 21/32; G06F 19/3456; G06F 19/322

(57) ABSTRACT

A wearable health information device can store, update and analyze patient medical records. In addition, the wearable health information device can alert the user to schedule a medical appointment. Having the patient medical records with the user at all times can decrease the chance of medical errors. For example, the user may not remember the names of all medicaments he is currently taking. This problem becomes more prominent with elderly as the number of prescribed medicaments increases. The user may also mix the dosage between two different prescribed medicaments.

### CROSS-REFERENCE TO RELATED APPLICATIONS

This application claims the benefit of priority from U.S. Provisional Application No. 62/103,848 filed Jan. 15, 2015, the entire contents of which are incorporated herein by reference.

### BACKGROUND

Providing a complete and accurate health record of a patient plays an important role in diagnosing illnesses. It is difficult to keep track of a complete patient medical record. Many medical facilities rely on the patient to fill their own medical health information. During doctor visits, the patient may accidentally fail to write an allergy he has or a medicament he is taking. In addition, many medicaments names are hard to remember and the patient may easily confuse the correct dosage. These errors may lead to severe outcomes and in some cases even death. Moreover, an adult may not remember surgeries he had as a child or the patient may change many physicians over the course of his life. In another instance, the patient may get involved in an accident and first responders may need immediate access to the patient medical record and relatives or caregiver may not be immediately available. A user may be unconscious or may not be able to respond to the first responders. Due to the reasons mentioned above there is a need of an easy to use device that will be universal, portable, and affordable.

In addition, some hospital and medical facilities still implement paper-record systems and other hospitals utilize a variety of non-compatible digital software. The user may have to login to different systems to view medical records. Moreover, doctors only have a limited access to patient's medical records pertaining to their practice. It is increasingly important for the user to have important medical information in one easily accessible place so that the user may provide a medical care provider with the latest health information thereby ensuring better health care for the user.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

A wearable health information device stores patient identification information and patient medical records in a memory. The wearable health information device comprises processing circuitry configured to update, transmit, output and analyze the patient medical records. The wearable health information device uses communication circuitry to access a network and transmit alerts and updates to a medical professional computer. The wearable health information device receives updates to the patient medical records through an interface and/or the communication circuitry. The wearable health information alerts a medical professional when a user fails to follow a prescribed treatment by monitoring a prescription refill status.

A method for health information monitoring is provided that comprises storing in the memory the patient identification information and the patient medical records, updating the patient medical records by an authorized users and alerting the user when the patient medical record is updated. Additionally, the method analyzes the patient medical records and alerts the medical professional when the user fails to follow the prescribed treatment by monitoring the prescription refill status.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a wearable health information device according to one example;

FIG. 2 is an exemplary schematic of a system for health information according to one example;

FIG. 3 is an exemplary schematic of multiple databases connectable to the wearable health information device according to one example;

FIG. 4 is an exemplary table for a doctor visits database according to one example;

FIG. 5 is an exemplary table for a hospital stays database according to one example;

FIG. 6 is an exemplary schematic of an identification information form according to one example;

FIG. 7 is an exemplary schematic of a taken medicament list according to one example;

FIG. 8 is an exemplary flow chart to display information according to one example;

FIG. 9 is an exemplary flow chart to update information according to one example;

FIG. 10 is an exemplary flow chart to update an already taken medicament list according to one example;

FIG. 11 is an exemplary flow chart to generate an alert according to one example;

FIG. 12 is an exemplary flow chart to generate an alert according to one example; and

FIG. 13 is an exemplary flow chart to generate an alert according to one example.

### DETAILED DESCRIPTION

Referring now to the drawings, wherein like reference numerals designate identical or corresponding parts throughout several views, the following description relates to a wearable health information device and associated methodology for recording and analyzing medical records of a user and generating appropriate alerts.

Specially, as shown in the drawings and related discussion, the wearable health information device can store, update and analyze patient medical records. In addition, the wearable health information device can alert the user to schedule a medical appointment. Having the patient medical records with the user at all times can decrease the chance of medical errors. For example, the user may not remember the names of all medicaments he is currently taking. This problem becomes more prominent with elderly as the number of prescribed medicaments increases. The user may also mix the dosage between two different prescribed medicaments.

The wearable health information device can be given to a newborn, and information is added and updated as the user becomes older, thereby compiling complete patient medical records. The wearable health information device is easy to use and instructions of how to use it may be provided along with it. Maintaining the patient's medical records connected to one device helps the user keep track of his most recent records in case he changes doctors, as an example. The wearable health information device is useful in emergencies, as first responders have easy access to, for example, blood type, an allergies list and all medicaments the user is currently taking.

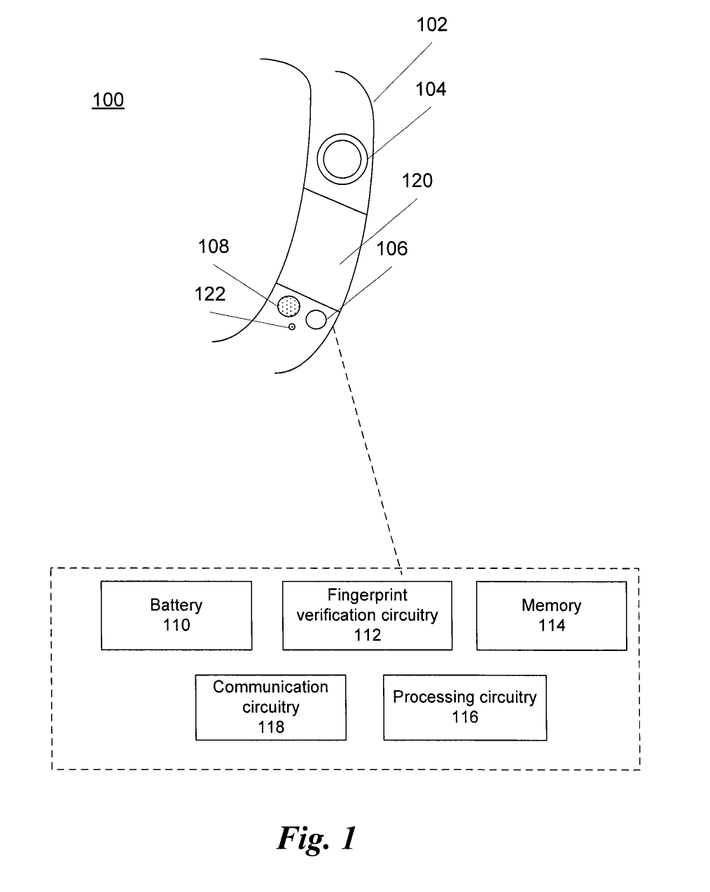

The wearable health information device may, in selected embodiments, be a bracelet, a pendant, a watch, an anklet, or other wearable device as would be understood to one of ordinary skill in the art. FIG. 1 shows the wearable health information device as the bracelet 100 according to one embodiment. The bracelet 100 may include an interface, such as a display screen 120 or a microphone 122. In one embodiment, the interface represents any medium that can accept input and/or output information as would be understood by one of ordinary skill in the art. The bracelet 100 may include an adjustable band 102, a fingerprint sensor 104, a display screen 120, a speaker 108 and a button 106. Further, enclosed in the bracelet 100 are a battery 110, a fingerprint verification circuitry 112, a memory 114, communication circuitry 118, processing circuitry 116 and a microphone 122. The battery 110 may be a rechargeable battery. The wearable health information device 100 may also include location detection circuitry. For example, Global Positioning System (GPS) circuitry may be included within the wearable health information device 100 as would be understood by one of ordinary skill in the art. The patient medical records may be shown via the display screen 120. The speaker 108 may be used for audible alerts or reading reports or other textual information stored on the bracelet 100 memory 114. The microphone 122 may be used for receiving voice dictation or other voice commands.

The processing circuitry 116 performs one or more of the processes, in conjunction or separately, described below. The process data and instructions may be stored in the memory 114. These processes and instructions may also be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the bracelet 100 communicates, such as a server or computer.

Further, the claimed advancements may be provided as a utility application, background daemon, or component of an operating system, or combination thereof, executing in conjunction with the processing circuitry 116 and an operating system such as Microsoft Windows 7, UNIX, Solaris, LINUX, Apple MAC-OS and other systems known to those skilled in the art.

The processing circuitry 116 may be a Xenon or Core processor from Intel of America or an Opteron processor from AMD of America, or may be other processor types that would be recognized by one of ordinary skilled in the art. Alternatively, the processing circuitry may be implemented on an FPGA, ASIC, PLD or using discrete logic circuits, as one of ordinary skilled in the art would recognize. Further, the processing circuitry 116 may be implemented as multiple processors cooperatively working in parallel to perform the instructions of the inventive processes described below.

The bracelet 100 also includes the communication circuitry 118, such as an Intel Ethernet PRO network interface card from Intel Corporation of America, for interfacing with network 202. As can be appreciated, the network 202 can be a public network, such as Internet, or a private network such as an LAN or WAN network, or any combination thereof, and can also include PSTN or ISDN sub-networks. The network 202 can also be wireless such as a cellular network including EDGE, 3G and 4G wireless cellular systems. The wireless network can also be WiFi, Bluetooth, or any other wireless form of communication that is known to one of ordinary skilled in the art.

A sound controller is also provided in the bracelet 100, such as Sound Blaster X-Fi Titanium from Creative, to interface with speakers 108 and microphone 122 thereby providing sounds and/or music. In one embodiment, the fingerprint sensor 104 may be that disclosed in U.S. Pat. No. 6,547,130, entitled “INTEGRATED CIRCUIT CARD WITH FINGERPRINT VERIFICATION CAPABILITY”, the entire disclosure of which is incorporated herein by reference. A description of the general features and functionality of the display screen 120, the button 106, the microphone 122 as well as the battery 110 is omitted herein for brevity as these features are known.

In selected embodiments, the wearable health information device 100 can further enclose a health monitoring apparatus. For example, the wearable health information device 100 may enclose a temperature sensor and an oxygen level sensor as would be understood by one of ordinary skill in the art. The applications of the wearable health information device 100 can also be extended to an activity tracker. In other embodiments, the wearable health information device 100 may also include applications such as playing media files.

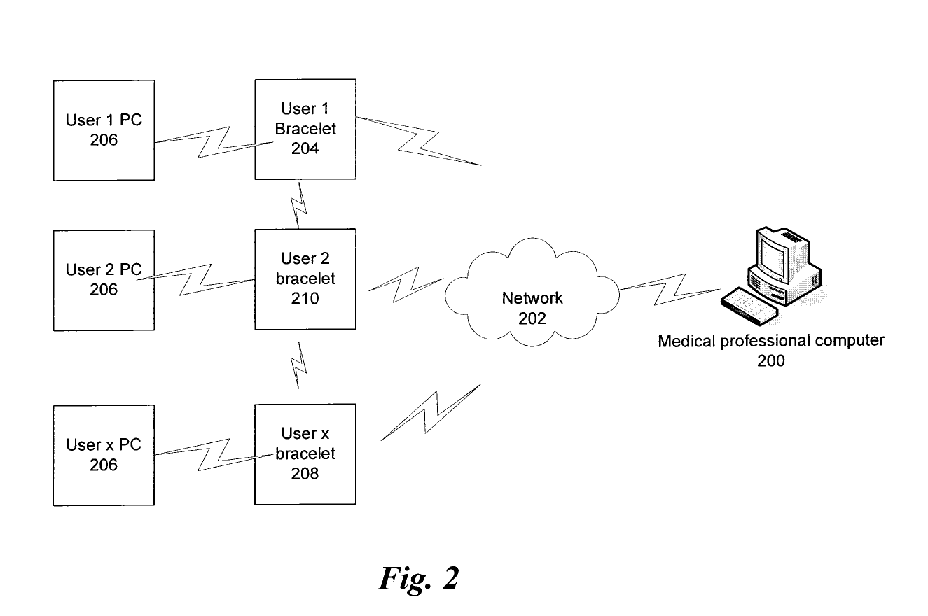

FIG. 2 shows an exemplary system of wearable health information devices 204, 208, 210 connected within a system having PCs 206, the network 202 and a medical professional computer 200 according to one example. The bracelets 204, 208 and 210 may connect via the communication circuitry 118 through the network 202 with the medical professional computer 200. The network 202 is any network that allows the bracelet and the medical professional computer 200 to communicate information with each other such as a Wide Area Network, Local Area Network or the Internet. The medical professional computer 200 represents one or more medical professional computers that could be located in a doctor's office, hospital or other medical facility or health facility that is used in the treating of patients as well as the review of patient records. A medical professional is any member of a health-related field having a professional status or membership as would be understood by one of ordinary skill in the art. Using the medical professional computer 200, a medical practitioner may access, view, and update a patient's medical records. Access to the patient medical records may be limited depending on a medical practitioner level, experience, special privileges or seniority. In other words, the access to the patient medical records may be restricted by the processing circuitry. For example, a nurse may be able to display the patient medical records and update specific fields but cannot delete the patient medical record or updated other fields whereas a doctor would be able to view medical records, update all fields and delete records or pieces of information where necessary.

One or more of bracelets 204, 208, 210 may also connect via the communication circuitry 118 to a personal computer 206. This allows the user to view personal medical records on the personal computer 206. The user may also update the personal medical records using the personal computer 206. For example, the user may connect the bracelet 100 to a PC 206 via the network 202 at which point the PC 206 may read and download information from the bracelet 100. This information may then be updated via a PC 206 interface, such as a keyboard and mouse, and then uploaded back to the bracelet 100. Alternatively, the PC 206 could be directly connected to the bracelet 100 such that updates could be sent via the network 202 to the records stored on the bracelet. As noted herein and in select embodiments, more than one bracelet 100 can connect to a one or more medical professional computers 200.

As described further below, one or more of the bracelets 204, 208 and 210 may connect with the medical professional computer 200 to provide updated information to the medical professional computer 200 so that a medical professional will be able to review the latest information with respect to a patient as well as historical data stored throughout the lifetime of the user. Information could also be downloaded to the bracelet 100 from the medical professional computer 200 such as patient medical records and other related medical history information. This information could then be compared to the information stored on the bracelet 100 to identify whether information is out of date on either the bracelet 100 or the medical professional computer 200. Further, information from the medical professional computer 200, such as prescription information, appointment changes and other information, may be sent to one or more bracelets 204, 208, 210 to update the user with the latest medical information.

Using the system illustrated in FIG. 2, the user may log on to his personal computer 206 to review medical records or other medical information stored on the bracelet 100. The user may also update medical records or medical information stored on the personal computer 206 and then transmit this updated information to the bracelet 100. The bracelets 204, 208 and 210 may also communicate with each other via the network 202 or another communication method as would be understood by one of ordinary skill in the art to update data therebetween. For example, the user of bracelet 204 may be related to the user of bracelet 208 and therefore it may be beneficial to share some medical information between them. Further, if the user of bracelet 204 monitors health information of a user who does not currently have their bracelet with them, the user of bracelet 204 may wish to exchange information to update the medical information on the other bracelet at a later time.

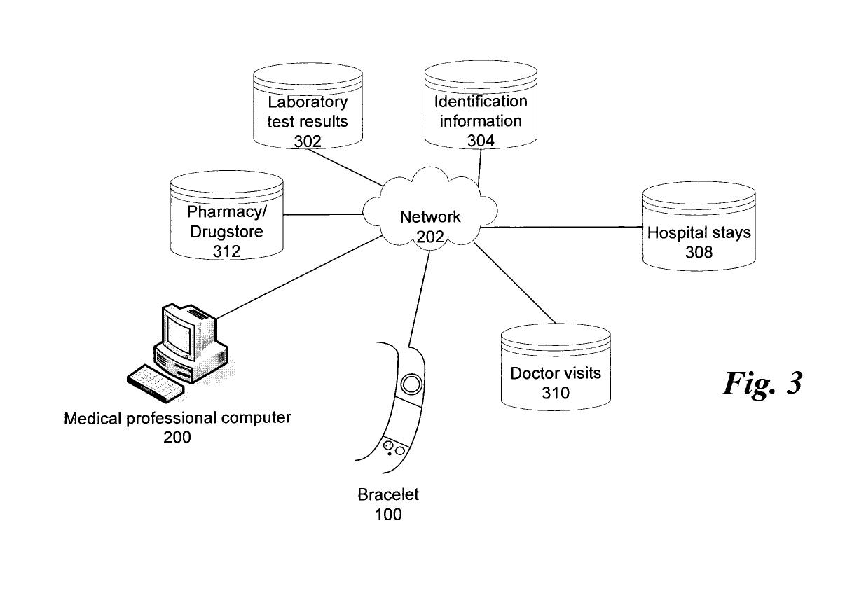

FIG. 3 shows multiple exemplary databases which may be connected to the wearable health information device 100 via the network 202. The databases may include, in selected embodiments, a laboratory test results database 302, an identification information database 304, a pharmacy database 312, a doctor visits database 310 and a hospital stays database 308. Information from the databases may be stored in the memory 114 of the wearable health information device 100. In other embodiments, the information from the databases may be also stored in the memory of the medical professional computer 200 or the personal computer 206. The bracelet 100 may check at a predetermined interval that the information stored is the most recent information. For example, if information is updated in the bracelet 100, the bracelet 100 may automatically upload the information to the medical professional computer 200 and to the personal computer 206 at predetermined intervals or every time an update is made. Similarly, the bracelet 100 may poll the databases at predetermined intervals to download any updated information from the databases thereby keeping the information, such as the patient medical records, up to date on the bracelet 100. It is noted that although FIG. 3 illustrates a plurality of separate databases, one database may store all of the information described above with respect to the databases.

The laboratory test results database 302 can store all laboratory test results along with the dates when the tests were taken. For example, laboratory tests results for multiple users for various tests, such as blood tests, can be stored in the laboratory test results database 302. An authorized medical practitioner may query the laboratory test results database 302 having information uploaded by the bracelet 100 to check, if a laboratory test has been recently ordered and to avoid duplicate ordering of the laboratory test by two different doctors thus reducing healthcare cost and user inconvenience. Further, when determining whether a particular test should be run on the patient, the medical practitioner may receive information stored on the bracelet 100 to determine whether or not the test has been performed recently and whether results have been received for the test. Information stored on the bracelet 100 may also indicate to the medical practitioner that a test is not necessary therefore saving the patient time and money as well as preventing duplicate or unnecessary medical work.

Further, the bracelet 100 can access the laboratory tests results database 302 to download from the laboratory test results database 302 or upload to the laboratory test results database 302. Accordingly, the user of the bracelet 100 may update the information stored therein based on information received from the laboratory test results database 302 and may upload recent laboratory results stored on the bracelet 100 to the laboratory test results database 302 to ensure the database 302 stores the latest laboratory tests results of the patient. Further, in selected embodiments, the bracelet 100 connects to the laboratory tests results database 302 and determines that additional laboratory results have been stored that were not previously included in the bracelet 100, the bracelet 100 may automatically download these results. The bracelet 100 may also run processing algorithms to determine the type of laboratory results and if the user has had any doctors appointments or hospital visits within a predetermined time frame that may relate to the laboratory results. For example, if the user had a medical visit or appointment relating to blood testing or blood factors within a predetermined period of time and the bracelet 100 recently downloaded blood tests from the database 302 that were within a predetermined time period and show the user to be free of a certain blood deficiency, the bracelet 100 may automatically upload (or prompt the user to upload) this information to the medical professional computer 200 to ensure that the doctor has the most recent information available with respect to the user before or at the time of the medical visit. To determine any similarities between medical appointments, medical conditions or the like and the laboratory tests, text matching and pattern matching having matching probabilities over a predetermined threshold to determine a relationship may be used as would be understood by one of ordinary skill in the art.

The pharmacy database 312 may store information about prescription refills. For example, the pharmacy database 312 can store a prescribed medicament name and duration of a treatment. The bracelet 100 can access the pharmacy database 312 to download from the pharmacy database 312 or upload to the pharmacy database 312. A prescription refill status may be used to check if the user is following a prescribed treatment. Accordingly, the bracelet 100 using the processing circuitry 116 can determine if the required and prescribed medicament have been refilled and picked up by the user. For example, if a required and prescribed medicament has to be refilled each 30 days, the bracelet 100 using the processing circuitry 116 could determine that 30 days has passed from the last refill by using an internal counter. The bracelet 100 could then access the pharmacy database 312 to determine if the user refilled the required and prescribed medicament within the 30 day time period. If the user fails to refill the prescribed medicament, the processing circuitry 116 alerts the medical computer 200 via the network 202 that the user is not taking the required and prescribed medicament. The pharmacy database 312 stores data from various pharmacies, which is useful if the user refills the prescribed medicament at a different pharmacy each time. The bracelet 100 may also run processing algorithms to check for drug interactions. The pharmacy database 312 may also store the name of nonprescription drugs such as supplements, herbal, and over-the-counter drugs. The bracelet 100 may automatically upload this information to the medical professional computer 200 to ensure that the doctor has the most complete information available to him when prescribing a new medicament.

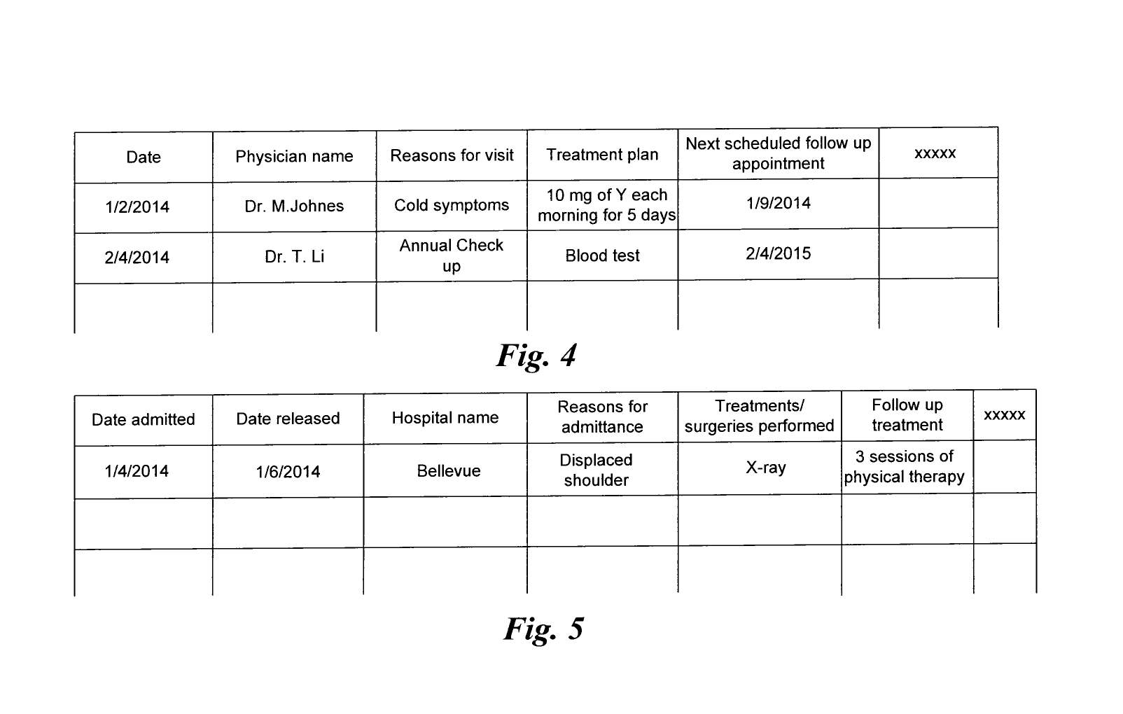

FIG. 4 shows an exemplary table showing the different fields stored in the doctor visits database 310. In selected embodiments, the table contains a doctor visit date, a physician name, a reason for visiting, a diagnosis, a treatment plan and a next scheduled follow up appointment date. The bracelet 100 may connect to the doctor visits database 310 to download from the doctor visits database 310 or upload to the doctor visits database 310. In one example, when the information is downloaded from the doctor visits database 310 to the bracelet 100 the processing circuitry 116 may analyze the table in order to generate an alert if the user visited a physician for the same reasons frequently and/or recently. The physician may not be aware that the user has visited other physicians for the same reasons or different reasons that can be caused by the same medical condition. Therefore, based on this alert, the physician may download information from the bracelet 100 which identifies the previous visit and the details surrounding that visit such as diagnosis/treatments. Once the physician performs any additional diagnosis the bracelet 100 may automatically store this information internally as well as upload this information to the medical professional computer 200. Accordingly, the user of the bracelet 100 may update the information stored in the doctor visits database 310. The processing circuitry 116 may check if the user of the bracelet 100 has made an appointment for a blood test and upload the information to the medical professional computer 200.

Other information could be utilized in conjunction with the information stored in the doctors visits database 310. For example, prescription information refill status information stored on the bracelet 100 can be transmitted to the medical professional computer 200 so that the doctor or physician has an understanding of medications the user is taking as well as whether the user is properly taking their medications. If the doctor prescribes a medication to the patient and this information is downloaded from the medical professional computer 200, the processing circuitry 116 can perform comparison processing to determine whether the medication has already been prescribed to the patient or if it merely an increase or decrease in the dosage size. If this is the case, the bracelet 100 may issue the alert indicating that the same prescription is being prescribed to the patient that has already been prescribed recently. The bracelet may determine an alert of less severity (lower sound, or light for example) if it determines that the patient was previously prescribed the medication but is done with the medication cycle.

Further, if the doctor enters information illustrated in FIG. 4 into the medical professional computer 200 which is then downloaded into the bracelet 100, either manually or through polling, the bracelet 100 can further perform processing to identify whether other doctors have identified similar symptoms or reasons for the patient visit. If this is the case, the alert may be sounded if a predetermined threshold amount of symptoms/reasons for visits have been diagnosed by one or more doctors within a predetermined period of time. If the threshold is met or exceeded, the bracelet 100 can issue the alert so that the doctor knows these symptoms have been discovered before and may perform further tests as it is clear the patient may not be getting better based on the original diagnosis.

FIG. 5 shows an exemplary table showing the different fields stored in the hospital stays database 308. In selected embodiments, the table contains a date admitted, a date released, a hospital name, reasons for admittance, treatments and/or surgeries performed and a follow up treatment plan. The processing circuitry 116 may analyze information stored in the table in order to alert the user to follow his prescribed treatment. The bracelet 100 can access the hospital stays database 308 and download from the hospital stays database 308 information such as the follow up treatment. The processing circuitry 116 can use text matching techniques to generate alerts to the user of bracelet 100. For example, the processing circuitry can recognize text such as “perform physical therapy twice a day” in the follow up treatment and generate alert to the user to remind him to perform the physical therapy exercise. The authorized medical practitioner may query the hospital stays database 308 to get a list of all prior surgeries performed. The authorized medical practitioner can update the list of surgeries performed. Then, the user of the bracelet 100 may update the information stored therein based on information received from the hospital stays database 308.

Additional alerts can be generated by the bracelet 100 based on the information contained within the hospital stays database 308. For example, the processing circuitry 116 can perform matching between the reasons for admittance and the reasons for a doctors visit which ware stored in the doctors visit database 310. This pattern matching can further be performed within a specific window of time based on the date information indicated in the doctor visits database 310 and the hospital stays database 308. If a match is detected, the alert can be generated to indicate to the hospital professional that the patient has recently been to the doctors office regarding similar reasons for admittance at the hospital. The hospital professional can then use this information to determine that they should further investigate the patients case and as to why they are still having symptoms. The hospital professional can also access the medical professional computer 200 which was recently updated to include all of the patients medical records information to determine as much information about the patient as possible.

For example, if the predetermined period of time for pattern matching is two weeks, and the user of the bracelet 100 has been to both the doctor and the hospital within this time frame for cold symptoms, the alert can be generated. The alert can also indicate the type of diagnosis by the doctor and/or medical professional as well as any medications prescribed and how long they have been taken by the patient. The alert can also include information such as tests which have been recently performed or tests results based on these tests thereby allowing medical professionals to assess the proper course of action based on the information received from the bracelet 100. These alerts can be performed in audio via the speaker or via the display screen interface.

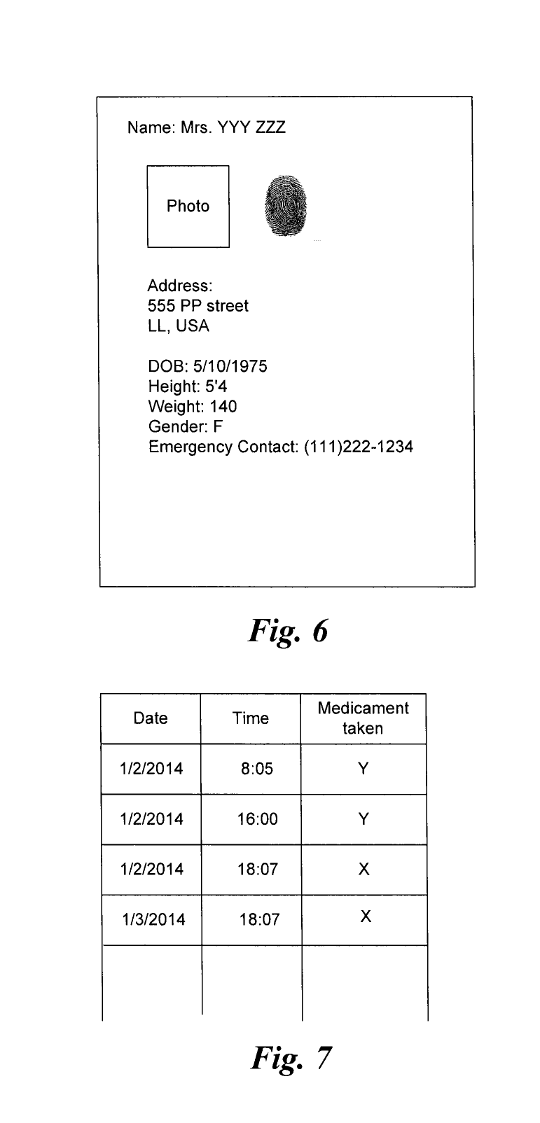

FIG. 6 shows an exemplary patient identification information form stored in the memory 114 and/or in the identification information database 304. The patient identification information may include one or more of, but not limited to, a name, a photo, a date of birth, a weight, a height, a gender, a skin color, a hair color, a next of kin and an identification number. In FIG. 6, the patient identification information includes at least one of the name, the photo, a fingerprint, an address, the date of birth, the height, the weight, the gender and an emergency contact number. In another embodiment, the processing circuitry 116 is further configured to monitor physiological parameters such as the weight. The user is notified in the case of sudden weight loss or weight gain.

The patient medical records can include, but are not limited to, at least one of the blood type, a vaccination list, an allergy list, a past surgeries list, insurance company information, a genetic diseases list, an immunization list, a family medical history and a prescribed medicament list.

FIG. 7 shows an exemplary schematic of an already taken medicament list. The bracelet 100 may record the name of any medicament taken along with the time and date in the already taken medicament list. The user can update the already taken medicament list via the button 106 or the microphone 122. Further, in selected embodiments, the display screen 120 may be a touchscreen. Using the touchscreen, the user may select the name of any medicament taken from a list. The medical professional computer 200 may access the already taken medicament list via the network 202. For example, in case of an emergency the caregiver using the medical professional computer 200 may access the bracelet 100 memory 114 to view the already taken medicament. The already taken medicament list is analyzed by the processing circuitry 116 in order to issue alerts to the user.

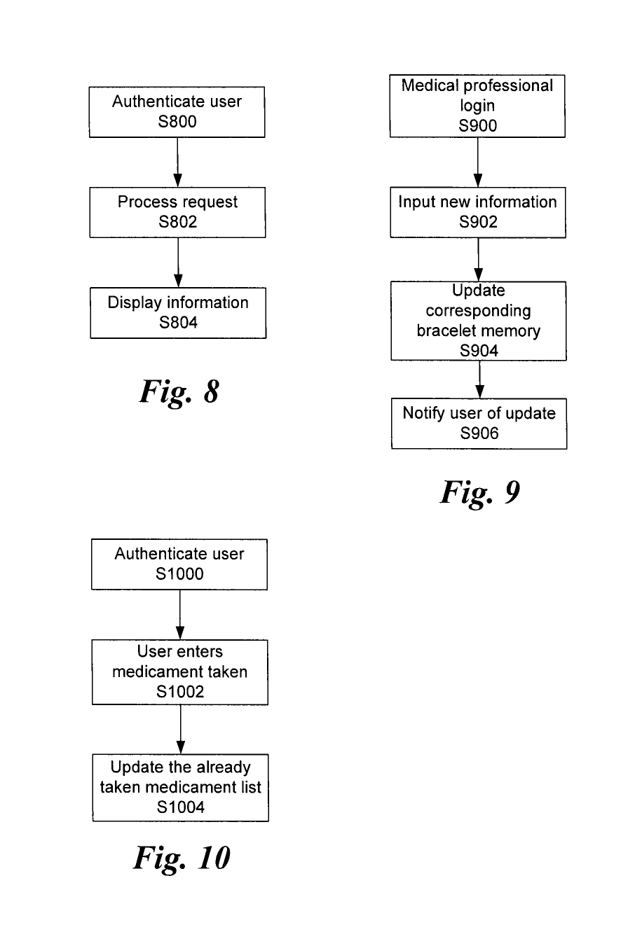

FIG. 8 shows an exemplary process to display information on the display screen 120. The process starts by authenticating the user at step 5800. The authentication can be performed by a variety of methods such as voice recognition via the microphone 122 or fingerprint recognition via the fingerprint sensor 104 of the bracelet 100. The fingerprint is verified using the fingerprint verification circuitry 112 by comparing the fingerprint with the fingerprint stored in the patient information records in the memory 114. In other example, the user may be authenticated by entering a pin code. A predetermined super pin number may be configured to work on all wearable health information devices and is only known by the authorized medical practitioner. The authorized medical practitioners include first responders, nurses and physicians and the like. The first responders may use the predetermined super pin number when the user is not able to provide information. Authorized persons may include health practitioners, guardians and relatives. The health information that an authorized person can display may depend on preset access privilege. For example, the physician can access the complete medical history while the first responders may have access only to a currently prescribed medicament list, the allergies list and the blood type. This ensures the privacy of the user. Once the user is authenticated and logged into the bracelet 100, the user may process a request at step 5802. For example, the user may query the pharmacy database 312 to display all the medicaments he is currently taking.

The first responders do not need special devices or access to the network 202 in order to access the user information. As all pertinent information can be displayed on the display screen 120, which makes the wearable health device universal, and not system dependent.

FIG. 9 shows an exemplary process to update the patient information record. The process starts by the medical professional logging in at step S900. For example, when the laboratory test results are received by the doctors, the medical professional may login in to the medical professional computer 200. Once the medical professional is logged in to the medical computer 200, the medical professional may input new information at step S902. The medical professional may type or scan the laboratory test results and add them to the patient medical records. The medical professional may also indicates any abnormal laboratory results. Once the medical professional has updated the patient medical records, the corresponding bracelet memory 114 is updated at step S904. Once the memory 114 is updated, the user of the bracelet 100 is notified that his medical records have been updated at step S906. For example, the alert is displayed on the wearable health information device 100 that his laboratory results are ready for viewing. In another example, the alert may be generated in the case of abnormal laboratory results and the patient is advised to schedule an appointment.

FIG. 10 shows an exemplary process to update the already taken medicament list. The process starts by authenticating the user at step S1000. The authentication can be performed by any of the methods described in conjunction with FIG. 8. Once the user is authenticated and logged into the bracelet 100, the user may enter the name of the medicament taken at step S1002. The user may enter the name of the medicament taken using the button 106 which can allow the user to scroll through text entry on the display 120 as would be understood by one of ordinary skill in the art. In another example, the user may use the microphone 122 to enter the name of the medicament taken. The processing circuitry 116 may use a speech recognition method to recognize the name of the medicament taken by the user. A parent or a guardian can login to a child bracelet 100 in order to enter the name of the medicament taken by the child. The caregiver can also enter the name of the medicament taken by an elderly. In other embodiments, the parent can use their own bracelet to update the already taken medicament list of the child. The parent can login to their own bracelet 100 then use the button 106 to choose the corresponding child bracelet and enter the name of the medicament taken. Once the user has entered the name of the medicament taken, the already taken medicament list is updated at step S1004. An exemplary already taken medicament list is shown in FIG. 7.

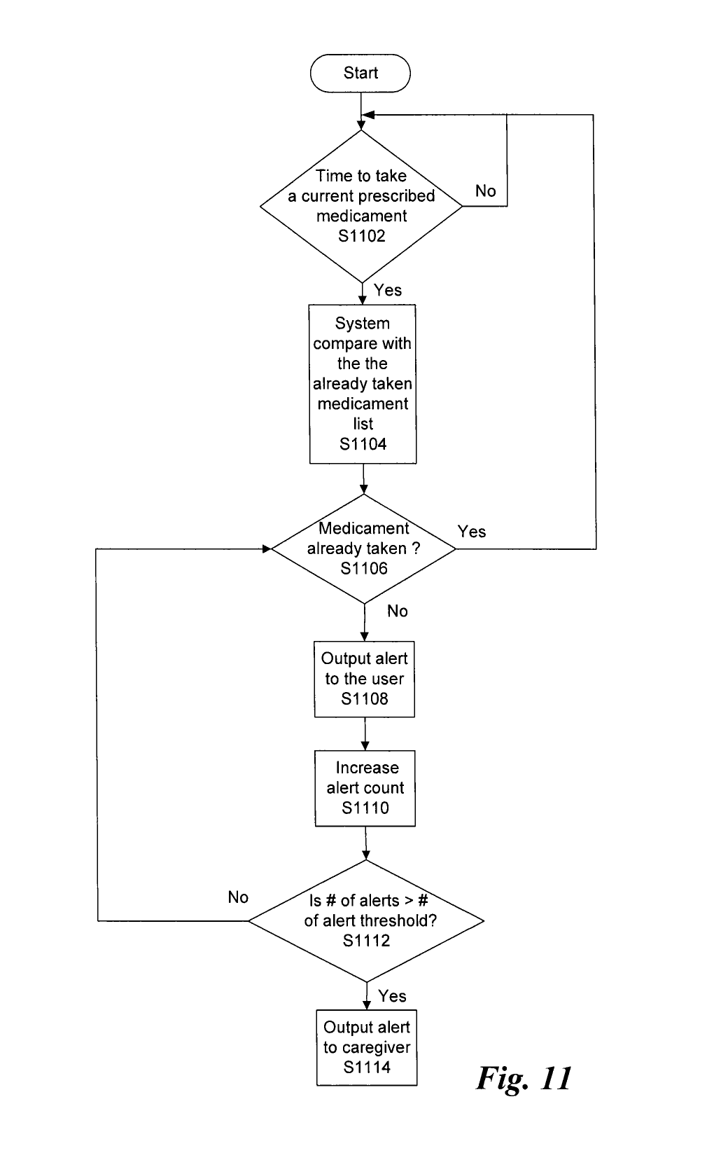

FIG. 11 shows an exemplary flowchart to check if the user is following the treatment plan. At S1102, the processing circuitry 116 checks if it is time to take a current prescribed medicament based on information programmed by the user of the bracelet 100 or based on information received from one or more of the pharmacy/drugstore database 312, hospital stays database 308 and doctors visits database 310. If it is time to take the prescribed medicament then the processing circuitry 116 checks the already taken medicament list at S1104. This list is updated by the user of the bracelet 100 or a guardian of the user of the bracelet 100 or via another bracelet as previously described herein. At S1106, if the prescribed medicament has been already taken then no alert is generated. If the medicament has not been taken then an alert is generated at S1108. The alert can be visual, audible or tactical. The volume of an audible alert, can be related to the number of alerts previously generated. For example, a low volume sound can play when the first alert is generated and the volume increases when the user is alerted a second time. The user may dismiss the alert. At S1110 and if the medicament has not yet been taken, an alert count/number is increased by a predetermined incremental value. At S1112, the processing circuitry 116 compares the alert number with a predetermined alert threshold. If the alert number is greater than the predetermined alert threshold then the alert to the medical professional computer 200 is generated at S1114 and transmitted to the caregiver via the network 202.

The type of alert generated for the caregiver may depend on the situation. If the user fails to take the prescribed medicament that may lead to rapid deterioration in his health, such as blood thinner medication, then the alert may be a flashing visual alert accompanied with a high audible sound. If the alert number is less than the predetermined alert threshold then the process goes to S 1106 after a predetermined period of time. The predetermined period of time may also be set manually or based on the type of medication that is being assessed by the processing circuitry 116 of the bracelet 100. Once the user takes his medicament the alert number is reset to zero. The predetermined alert threshold may be different for different prescribed medicaments and therefore can be based on the type of medicament being taken by the user of the bracelet 100. For example, the predetermined alert threshold may be higher for a vitamin than a psychoactive drug. In one example, the parent or guardian may monitor the child. If the child enters the name of a medicament he has taken, the parent needs to verify that the child has indeed taken the medicament before the taken medicament list is updated. Once the child enters the name of the medicament taken, the parent or guardian is notified via the communication circuitry 118. At this point, the processing circuitry 116 of the bracelet 100 may request from the guardian, via the bracelet 100 or by sending a wireless alert to the guardian (i.e, email, text, etc), authentication before proceeding to update the taken medicament list of the child. The parent or guardian is then required to be authenticated via the fingerprint sensor or by entering a special pin code not known by the child to validate that the child took the medicament. Once the authentication information has been received by the bracelet 100, the processing circuitry 116 proceeds to update the taken medicament list based on one of what the child entered or based on what information the guardian entered or a combination thereof. The caregiver should also validate that the elderly has indeed took the medicament before the taken medicament list is updated.

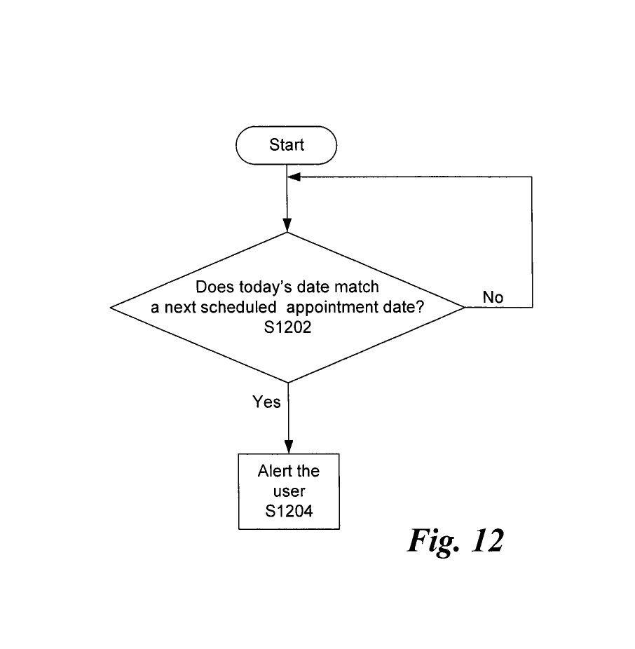

FIG. 12 shows an exemplary flowchart to remind the user that he has a scheduled appointment today. At S 1202 the processing circuitry checks if today's date corresponding to a scheduled appointment date. For example, the bracelet 100 download information from the doctor visits database 310, then the processing circuitry 116 match today's date with the next scheduled follow up appointment. If today's date corresponds to a next scheduled appointment date then, at S1204, the user is alerted.

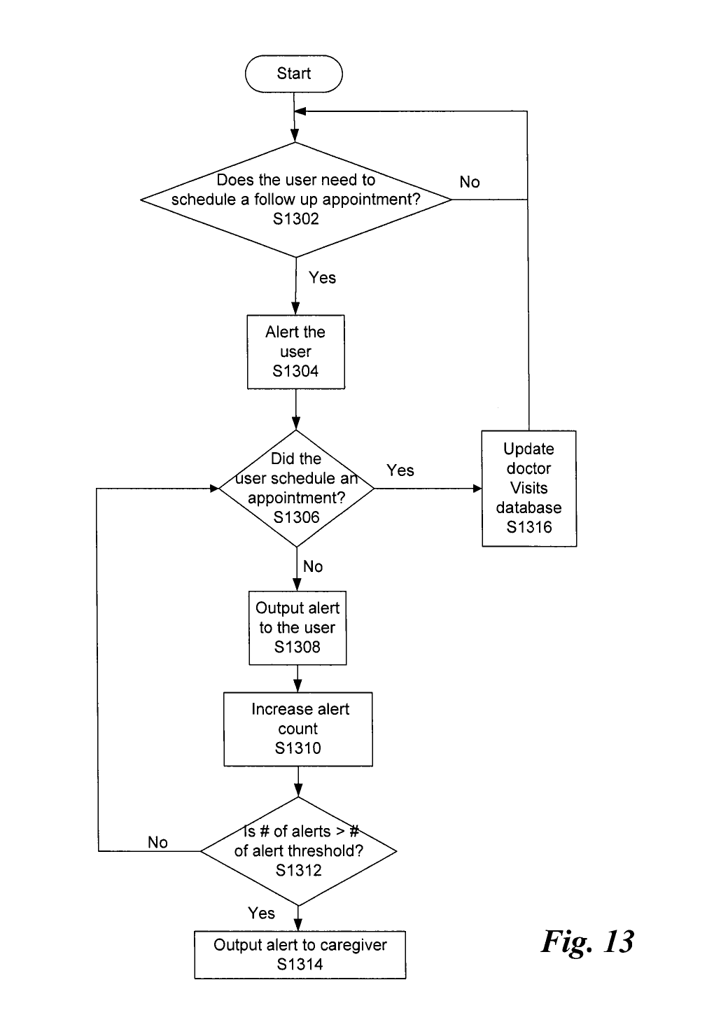

FIG. 13 shows an exemplary flowchart to monitor that the user needs to schedule a follow up appointment. At S1302, the processing circuitry 116 queries the doctor visit database 310 and the hospital stays database 308. Text matching techniques may be used by the processing circuitry 116 to determine if the follow up appointment is needed. For example, text such “follow up after 2 months” can be recognized by the processing circuitry 116 in the doctor visit database 310. The processing circuitry 116 checks the date when this information was entered and uses this date to obtain the date when the next follow up appointment should be scheduled. If there is a need to schedule the follow up appointment then the user is alerted at S1304. If there is, no need to schedule the follow up appointment the processing circuitry 116 may check at a later time. At S1306, the processing circuitry 116 may check if the user has scheduled the follow up appointment by checking the databases. If the follow up appointment has not been scheduled then at S1308 the alert is generated to the user reminding him to schedule the follow up appointment. At S1310, the alert count/number is increased by a predetermined increment, such as one. At S1312, the processing circuitry 116 compares the alert number with the predetermined alert threshold. If the alert number is higher than the predetermined alert threshold than at S1314, the alert is generated to the caregiver.

In other embodiment, the device can automatically detect that the user has entered a hospital or a doctor office and generate the alert asking the user if the user wants to update the doctor visits 310 or the hospital stays database 308 based on the information contained within the bracelet 100 or update the bracelet 100 based on the information contained in the doctors visit 310 database and/or hospital stays database 308. This can be accomplished by having the circuitry 116 in the bracelet 100 determine the location of the user via GPS or other location-identifying methods as would be understood by one of ordinary skill in the art and comparing it to address information or information relating to the location of the hospital or doctors office which is stored in the memory 114 of the bracelet and determining whether the user is within a predetermined distance of the hospital or doctors office. In case the user is admitted to the hospital, the wearable health device may further be used to identify the patient and to ensure accurate drug administration thus reducing the risk of administrating the drug to the wrong patient or the wrong dosage.

A device that includes the features in the foregoing description provides numerous advantages to users. In particular, the device helps patients, caregivers and medical professionals monitor health information and have access to the current update health information of the user thus minimizing medical mistakes. Using the wearable health information device in combination with the medical database system makes the medical professional work more efficient. The wearable health information device also helps users remember to schedule preventive care appointments, which helps them have a healthier life and thus reducing healthcare costs. Further, as some hospitals still implement paper-record systems and other hospitals utilize a variety of non-compatible digital software, it is increasingly important for the user to have important medical information in one easily accessible place so that the user may provide a medical care provided with the latest health information thereby ensuring better health care for the user.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limit the scope of the invention, as well as other claims. The disclosure, including any readily discernible variants of the teachings herein, define, in part, the scope of the foregoing claim terminology such that no inventive subject matter is dedicated to the public.

### EXEMPLARY IMPLEMENTATIONS

### Health Information Monitoring

A. A wearable health information device comprising:
communication circuitry configured to access a network;
a memory that stores patient identification information and patient medical records;

an interface; and
processing circuitry configured to
   update a patient medical record when updates are received by the communication circuitry via the network and/or the interface,
   transmit, via the communication circuitry, a most recently updated patient medical record to an external entity,
   analyze the patient medical record,
   output, on a display screen, the patient medical record, and
   alert, via the communication circuitry, a medical professional when a user fails to follow a prescribed treatment by monitoring a prescription refill status.

B. The device according to A, further comprising:
a fingerprint sensor to authenticate the user by comparing an authorized fingerprint stored in the memory with a fingerprint obtained via the fingerprint sensor.

C. The device according to A, wherein the patient identification information includes at least one of a name, a photo, a date of birth, a weight, a height, a gender, a skin color, a hair color, a next of kin and an identification number.

D. The device according to A, wherein the patient medical record includes at least one of a blood type, a vaccination list, an allergies list, a past surgeries list, insurance company information, a genetic diseases list, an immunizations list, a family medical history and a prescribed medicament list.

E. The device according to A, wherein the communication circuitry generates an alert, on the display screen, in response to the patient medical record being updated.

F. The device according to B, wherein the communication circuitry
receives, via the interface, information identifying one or more medicaments taken by the user of the wearable health information device, and
updates, a taken medicament list and stores the taken medicament list in the memory.

G. The device according to F, wherein the processing circuitry is further configured to
compare the prescribed medicament list against the taken medicament list,
output a reminder alert when the user fails to take a prescribed medicament,
update an alert counter,
reset the alert counter when the user takes the prescribed medicament, and
alert the medical professional that the user did not take the prescribed medicament when the alert counter is greater than a predetermined threshold.

H. The device according to G, wherein the predetermined threshold is set based on the type of prescribed medicament.

I. The device of claim F, wherein only a guardian of the user can update the taken medicament list of the user of the wearable health device.

J. The device according to H, wherein the processing circuitry is further configured to
alert, via the communication circuitry, the guardian when the user indicates, via the interface, that the prescribed medicament has been taken,
request, in response to the indication by the user, authentication of the guardian via the interface or fingerprint sensor, and
update, in response to authenticating the guardian, the taken medicament list.

K. The device according to A, wherein the processing circuitry restricts at least a portion of the patient medical record based on a practitioner level.

L. The device according to A, wherein the wearable health information device automatically alerts the user to schedule a medical appointment.

M. The device according to A, wherein the wearable health information device automatically alerts the user to update the patient medical record when the user is allocated within a predetermined distance of a medical facility.

N. The device according to A, wherein a type of the alert is associated with an importance of an event causing the alert to be generated.

O. The device according to A, wherein
the communication circuitry receives, via the network, at least two of information relating to laboratory results, information relating to pharmaceuticals, information relating to hospital visits and information relating to doctors visits, the information further relating to the patient, and
the processing circuitry stores the information in the memory.

P. The device according to O, wherein the processing circuitry compares the received information and generates the alert when the information contains similarities.

Q. The device according to P, wherein
the communication circuitry receives information relating to doctors visits and information relating to hospital visits, the information indicating a reason for admittance, and
the processing circuitry generates the alert in response to determining that the reasons for admittance with respect to doctors visits is the same as information with respect to hospital visits.

R. The device according to Q, wherein the processing circuitry generates the alert only when the processing circuitry determines the reasons for admittance with respect to doctors visits is the same as information with respect to hospital visits within a predetermined time period.

S. A health information monitoring method comprising:
storing, in a memory, patient identification information and patient medical records;
updating, via processing circuitry, a patient medical record when updates are received by communication circuitry via a network and/or an interface;
transmitting, via the communication circuitry, a most recently updated patient medical record to an external entity;
analyzing, via the processing circuitry, the patient medical record; and
alerting, via the communication circuitry, a medical professional when a user fails to follow a prescribed treatment by monitoring a prescription refill status.

T. A non transitory computer readable medium having computer-readable instructions stored therein for health information monitoring that when executed by a computer causes the computer to perform a method comprising:
storing, in a memory, patient identification information and patient medical records;
updating, via processing circuitry, a patient medical record when updates are received by communication circuitry via a network and/or an interface;
transmitting, via the communication circuitry, a most recently updated patient medical record to an external entity;
analyzing, via the processing circuitry, the patient medical record; and
alerting, via the communication circuitry, a medical professional when a user fails to follow a prescribed treatment by monitoring a prescription refill status.

1. A wearable health information device comprising:
communication circuitry configured to access a network;
a memory that stores patient identification information and patient medical records;
an interface; and
processing circuitry configured to
update a patient medical record when updates are received by the communication circuitry via the network and/or the interface,
transmit, via the communication circuitry, a most recently updated patient medical record to an external entity,
analyze the patient medical record,
output, on a display screen, the patient medical record, and
alert, via the communication circuitry, a medical professional when a user fails to follow a prescribed treatment by monitoring a prescription refill status.

2. The device of claim 1, further comprising:
a fingerprint sensor to authenticate the user by comparing an authorized fingerprint stored in the memory with a fingerprint obtained via the fingerprint sensor.

3. The device of claim 1, wherein the patient identification information includes at least one of a name, a photo, a date of birth, a weight, a height, a gender, a skin color, a hair color, a next of kin and an identification number.

4. The device of claim 1, wherein the patient medical record includes at least one of a blood type, a vaccination list, an allergies list, a past surgeries list, insurance company information, a genetic diseases list, an immunizations list, a family medical history and a prescribed medicament list.

5. The device of claim 1, wherein the communication circuitry generates an alert, on the display screen, in response to the patient medical record being updated.

6. The device of claim 2, wherein the communication circuitry
receives, via the interface, information identifying one or more medicaments taken by the user of the wearable health information device, and
updates, a taken medicament list and stores the taken medicament list in the memory.

7. The device of claim 6, wherein the processing circuitry is further configured to
compare the prescribed medicament list against the taken medicament list,
output a reminder alert when the user fails to take a prescribed medicament,
update an alert counter,
reset the alert counter when the user takes the prescribed medicament, and
alert the medical professional that the user did not take the prescribed medicament when the alert counter is greater than a predetermined threshold.

8. The device of claim 7, wherein the predetermined threshold is set based on the type of prescribed medicament.

9. The device of claim 6, wherein only a guardian of the user can update the taken medicament list of the user of the wearable health device.

10. The device of claim 8, wherein the processing circuitry is further configured to
alert, via the communication circuitry, the guardian when the user indicates, via the interface, that the prescribed medicament has been taken,
request, in response to the indication by the user, authentication of the guardian via the interface or fingerprint sensor, and
update, in response to authenticating the guardian, the taken medicament list.

11. The device of claim 1, wherein the processing circuitry restricts at least a portion of the patient medical record based on a practitioner level.

12. The device of claim 1, wherein the wearable health information device automatically alerts the user to schedule a medical appointment.

13. The device of claim 1, wherein the wearable health information device automatically alerts the user to update the patient medical record when the user is allocated within a predetermined distance of a medical facility.

14. The device of claim 1, wherein a type of the alert is associated with an importance of an event causing the alert to be generated.

15. The device of claim 1, wherein
the communication circuitry receives, via the network, at least two of information relating to laboratory results, information relating to pharmaceuticals, information relating to hospital visits and information relating to doctors visits, the information further relating to the patient, and
the processing circuitry stores the information in the memory.

16. The device of claim 15, wherein the processing circuitry compares the received information and generates the alert when the information contains similarities.

17. The device of claim 16, wherein
the communication circuitry receives information relating to doctors visits and information relating to hospital visits, the information indicating a reason for admittance, and
the processing circuitry generates the alert in response to determining that the reasons for admittance with respect to doctors visits is the same as information with respect to hospital visits.

18. The device of claim 17, wherein the processing circuitry generates the alert only when the processing circuitry determines the reasons for admittance with respect to doctors visits is the same as information with respect to hospital visits within a predetermined time period.

19. A health information monitoring method comprising:
storing, in a memory, patient identification information and patient medical records;
updating, via processing circuitry, a patient medical record when updates are received by communication circuitry via a network and/or an interface;
transmitting, via the communication circuitry, a most recently updated patient medical record to an external entity;
analyzing, via the processing circuitry, the patient medical record; and
alerting, via the communication circuitry, a medical professional when a user fails to follow a prescribed treatment by monitoring a prescription refill status.

20. A non transitory computer readable medium having computer-readable instructions stored therein for health information monitoring that when executed by a computer causes the computer to perform a method comprising:
storing, in a memory, patient identification information and patient medical records;
updating, via processing circuitry, a patient medical record when updates are received by communication circuitry via a network and/or an interface;
transmitting, via the communication circuitry, a most recently updated patient medical record to an external entity;
analyzing, via the processing circuitry, the patient medical record; and
alerting, via the communication circuitry, a medical professional when a user fails to follow a prescribed treatment by monitoring a prescription refill status.
